(19) United States
(12) Patent Application Publication
(10) Pub. No.: US 2003/0160824 A1
(43) Pub. Date: Aug. 28, 2003

(54) Organizing and producing a display of images, labels and custom artwork on a receiver

(75) Inventor: Thomas P. Szumla, Lockport, NY (US)

Correspondence Address: Thomas H. Close, Patent legal Staff, Eastman Kodak Company, 343 State Street, Rochester, NY, 14650-2201, US

(73) Assignee: Eastman Kodak Company

(21) Appl. No.: 10/086,110

(22) Filed: Feb. 28, 2002

(51) Int. Cl. G09G 5/00

(52) U.S. Cl. 345/769; 345/764

(57) ABSTRACT

An electronic album creation system that includes: an album construction window having an open, blank electronic canvas defining an open raster space such that the raster space receives a wide variety of graphics, text, and photos in a random fashion; a portfolio window of selected displayed images; digital toolbars containing icons that represent artistic and operational functions; drag and drop selection means for placing unfinished templates within the electronic canvas; and personalized creative art tools that define a user's selective input for artistic composition, color, and placement in the electronic album.

### FIELD OF THE INVENTION

The invention relates to the displaying and annotating of images. More specifically, the present invention relates to organizing and producing a display of images to a receiver with the use of a digital processor that also provides artistic tools for the use of the album/scrapbook creator or hobbyist.

### BACKGROUND OF THE INVENTION

People enjoy collecting photographs of special events in their lives and organizing them in albums or scrapbooks. The person wishing to organize their photographs into albums or scrapbooks have two alternatives available to them. The first option is to manually arrange, annotate, and decorate their album or scrapbook. (Herein, album and scrapbook are equivalent terms and are used interchangeably). An alternative approach is to construct an electronic form of the album or scrapbook. Using the latter approach to constructing an album, one has many software options available, however the conventional software programs offered to the public do not contain the option to create decorative artwork like that available to those who construct and decorate their albums manually. The option to create decorative artwork affords manual album constructors great pleasure.

U.S. Pat. No. 6,327,048 entitled “Organizing And Producing A Display Of Images On A Receiver,” issued Dec. 4, 2001 to Wen; U.S. Pat. No. 6,123,362 entitled “System And Method Of Constructing A Photo Collage,” issued Sep. 26, 2000 to Squilla et al.; and U.S. Pat. No. 4,718,784 entitled “Rating Plate Printing Apparatus And Method,” issued Jan. 12, 1988 to Drisko describe systems and methods for the creation of electronic photo pages that can be used to create a scrapbook or photo album. The methods described in this prior art describe severally limited or no artwork creation features. Hence, what is needed is software for creating decorative artwork during constructing electronic album or scrapbooks.

### SUMMARY OF THE INVENTION

The above need is met according to the present invention by providing an electronic album creation system that includes: an album construction window having an open, blank electronic canvas defining an open raster space such that the raster space receives a wide variety of graphics, text, and photos in a random fashion; a portfolio window of selected displayed images; digital toolbars containing icons that represent artistic and operational functions; drag and drop selection means for placing unfinished templates within the blank electronic canvas; and personalized creative art tools that define a user's selective input for artistic composition, color, and placement in the electronic album.

### ADVANTAGES

The present invention has the advantage that the user can organize images on a receiver or label (which in turn can be applied to a receiver), and create attractive artwork that can be printed along with the images and labels on the same receiver or label.

With the present invention, the user inputs photograph information (size and number of pictures), and page layout information (wallpaper, corner artwork, picture frame, or large artwork creation). The first step in composing a photo album page is for the user to pick out or specify an album page layout. The user can work interactively with the software to create a page from scratch or he/she can begin the process using predefined layouts available from the software. When the user is satisfied with the page layout, she then can begin pasting pictures and artwork, laying down wallpaper, and labeling photographs.

From the tool bar in the main window or desktop, the user can step into artistic tools such as the wallpaper creator, the artwork template and painting tool, and a photo editing tool, where photographs can be edited and/or processed for presentation using typical image processing techniques such as cropping, resizing, and so on. When the user is done preparing the album page, she will then be able to preview the printed version of the page on the monitor screen, save it for use in perhaps a web page, or print it out on to a self-adhesive label like media or receiver with pre-punched holes to accommodate binding into a scrapbook or album.

### BRIEF DESCRIPTION OF THE DRAWINGS

For a more complete understanding of the present invention, including its features and advantages, reference is made to the following detailed description of the invention, taken in conjunction with the accompanying drawings in which:

FIG. 1 is a diagram illustrating a prior art computer system for online scrapbook construction;

FIG. 2 illustrates an album made up of a plurality of receivers;

FIG. 3 is a flowchart illustrating the procedure the user would perform to design an album page using the album kit;

FIG. 4 is an example of an image raster of an album page;

FIG. 5A is an example window or program desktop used as a GUI for the creative photo album software, particularly for the album construction Window;

FIG. 5B is the menu bar and pop-up menus for the album construction window;

FIG. 6A is an example window or program desktop used as a GUI for the custom artwork template tool;

FIG. 6B is a schematic of the toolbar for the custom artwork template tool;

FIG. 6C is a schematic of the shrink/enlarge scrollbar for the custom artwork template tool;

FIG. 7A is an example window or program desktop used as a GUI for the wallpaper creation tool;

FIG. 7B is the toolbar for the wallpaper creation tool;

FIG. 8A is an example window or program desktop used as a GUI for the corner artwork tool window;

FIG. 8B is the toolbar for the corner artwork tool window;

FIG. 9A is an example window or program desktop used as a GUI for the photo import-editing tool; and

FIG. 9B is the toolbar for the photo import-editing tool.

Corresponding numerals and symbols in these figures refer to corresponding parts in the detailed description unless otherwise indicated.

### DETAILED DESCRIPTION OF THE INVENTION

In the following description, a preferred embodiment of the present invention will be described as a software program. Those skilled in the art will readily recognize that the equivalent of such software may also be constructed in hardware. Because image manipulation algorithms and systems are well known, the present description will be directed in particular to algorithms and systems forming part of, or cooperating more directly with, the method in accordance with the present invention. Other aspects of such algorithms and systems, and hardware and/or software for producing and otherwise processing the image signals involved therewith, not specifically shown or described herein may be selected from such systems, algorithms, components, and elements known in the art. Given the description as set forth in the following specification, all software implementation thereof is conventional and within the ordinary skill in such arts.

The computer program may be stored in a computer readable storage medium, which may comprise, for example; magnetic storage media such as a magnetic disk (such as a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program. The present invention can be performed on any well-known computer system, such as a personal computer.

The present invention addresses the need to give the digital or electronic photo album creator additional tools to create, without imposed restrictions such as pre-defined templates, an album with the artistic features that are available when an album is constructed manually. Such features include the user creation of customized wallpaper for the background of the photo page, or art creation tools to help the user create custom artwork or page corner artwork (i.e., decorative artwork to be inserted on the page corner).

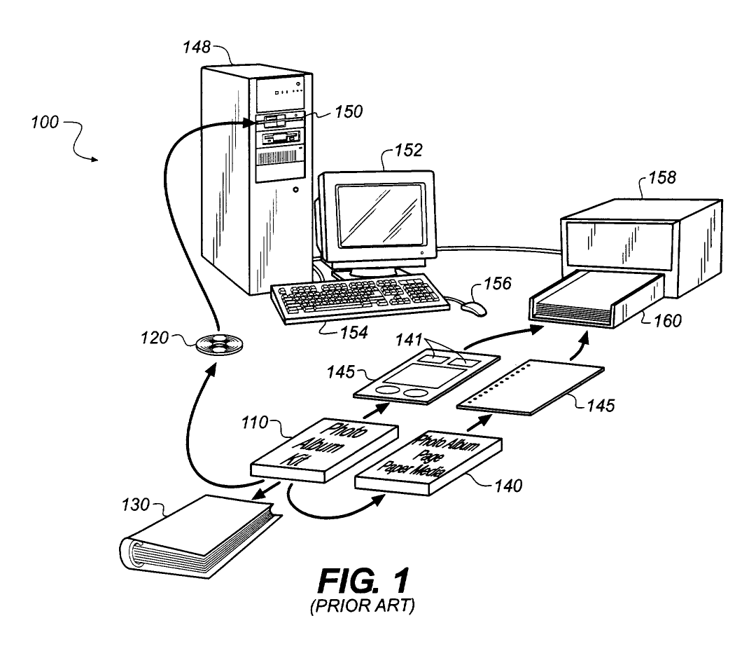

FIG. 1 illustrates a prior art computer system 100 for online scrapbook construction. The computer system 100 utilizes a full scrapbook kit 110 that includes a computer disk 120, (CD or DVD format) with software templates, a scrapbook binder 130, and multi-purpose media 140. The software templates usually found on the computer disk are pre-existing formats that are available for a scrapbook creator to choose from. These pre-existing formats can include text, foreground graphics, background color, and clip-art. The templates also allow a user to resize and reposition graphics.

The remainder of the computer system 100 includes a computer hard-drive 148 with CD or DVD drive 150, a monitor 152 and a keyboard 154, a printer 158 having a paper tray 160. The computer system 100 also includes both or either a digital camera and/or scanner (not shown). The computer system 100 may be optionally connected to the internet. The computer system 100 can be a laptop or a handheld device or an appliance tool with processing power, a cable setbox, or gaming device such as Sony Playstation 2, Microsoft X-box, or others. Using the CD 120 or alternatively downloading the software from a web site, the user installs the photo album/scrapbook creation tool. The software installs and executes on the desktop of the computer system 100. The digital photographic images are printed out using a printer 158 connected to this same computer system 100, by way of local printer port, local area network, or by way of Internet. The user loads the full-page photo album multi-purpose media 140 or alternatively, self-adhesive labels 141 with carrier 145 into the paper tray 160 of the printer 158.

In one embodiment, the prior art invention includes a full scrapbook kit 110. The full scrapbook kit 110 includes multi-purpose media 140 upon which the images and the user's creative artwork are printed, a scrapbook binder 130 and a compact disk (CD) 120 that contains the creative tool software and prepared templates, artwork, and other graphic items for the user. The software tool when launched will create a graphical user interface, sometimes referred to as a program desktop or window. Within such a window is a tool bar from which the user can digitize photographs, select an album page format, select creative tools, preview the printable album page, and finally print out one or more pages of the photo album.

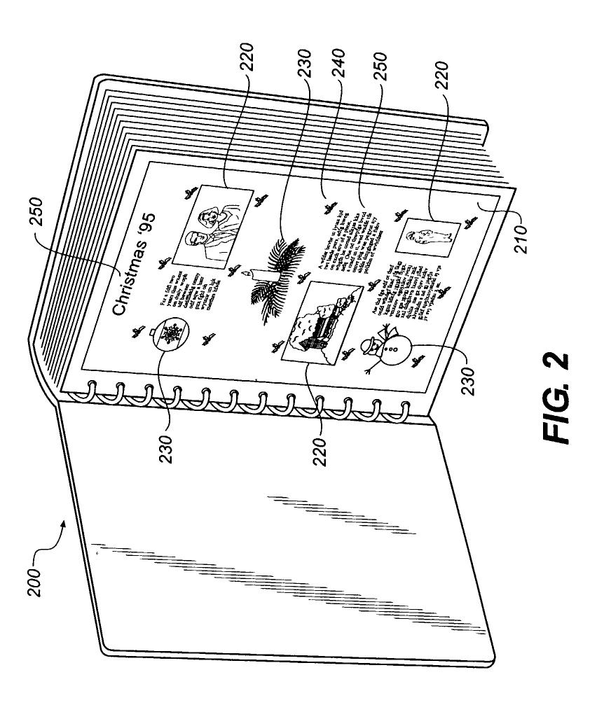

FIG. 2 shows a scrapbook 200 produced by the method of the present invention that includes photos 220, user created artwork 230, user created background 240, hereinafter, referred to as wallpaper 240, and text 250 placed on a receiver page 210. The receiver page 210 can be a full page paper-based media with pre-punched holes for insertion into the scrapbook 200. An alternative receiver page 210 is user-supplied paper having personalized labels that may be of the self-adhesive type. The scrapbook usually will have multiple receiver pages, but may also have only a single receiver page 210. The photographs included in this scrapbook 200 can be existing photographs that are affixed to the receiver pages 210, or can be digitized images that have become part of the image raster of the scrapbook's receiver page 210. A description of how a user constructs a scrapbook 200 follows.

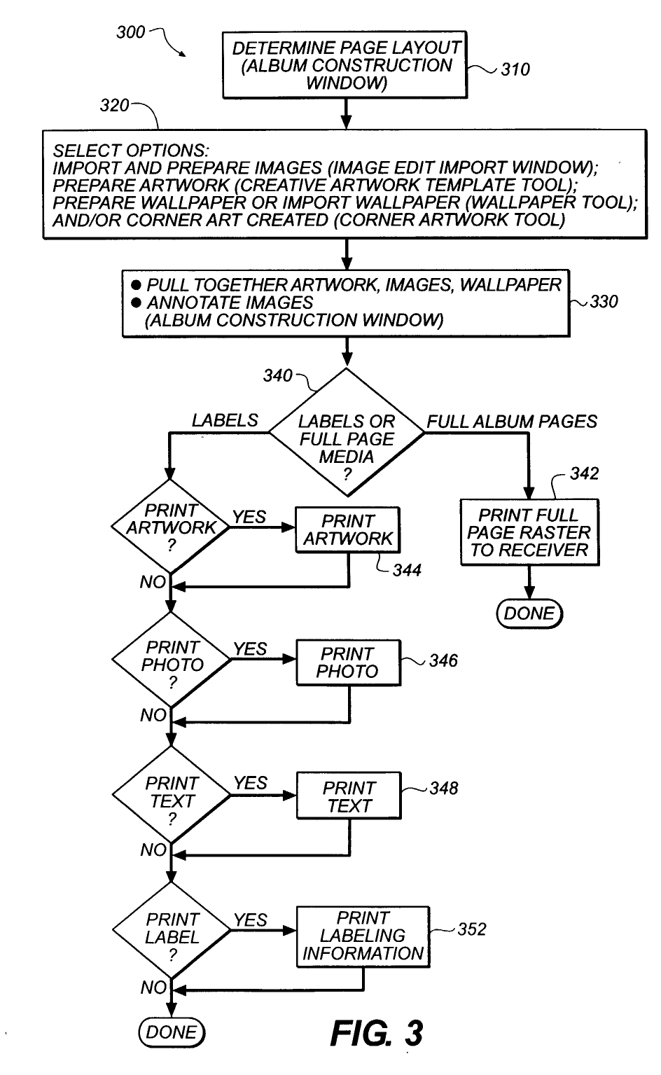

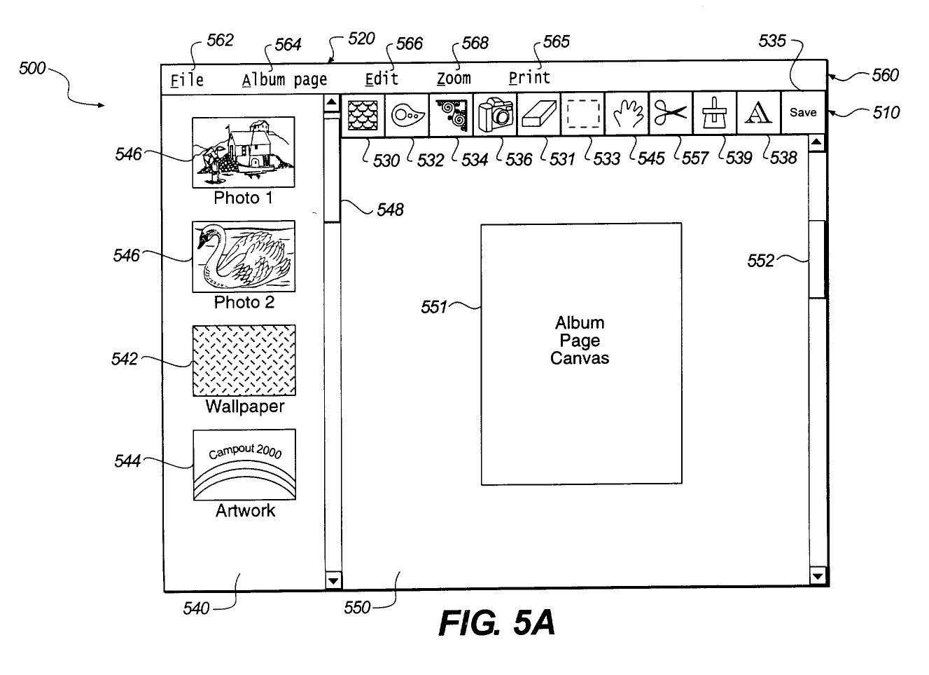

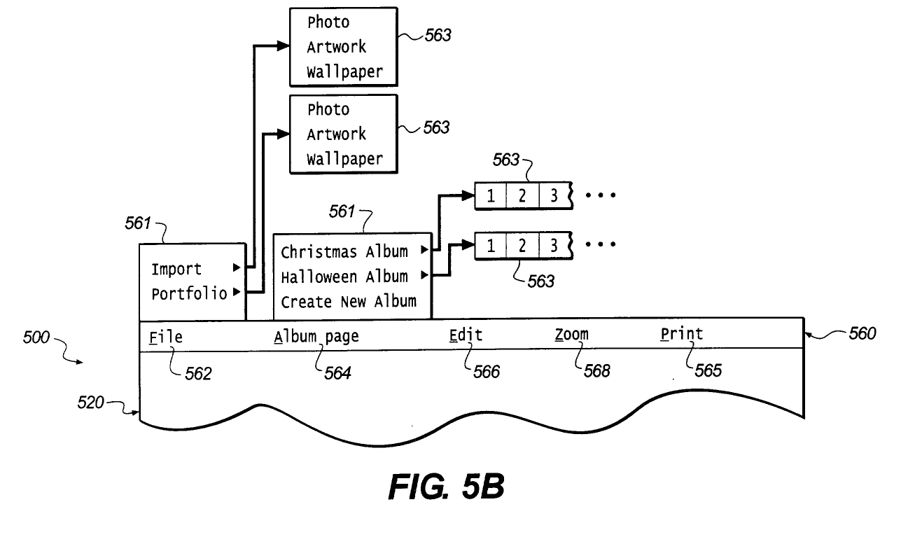

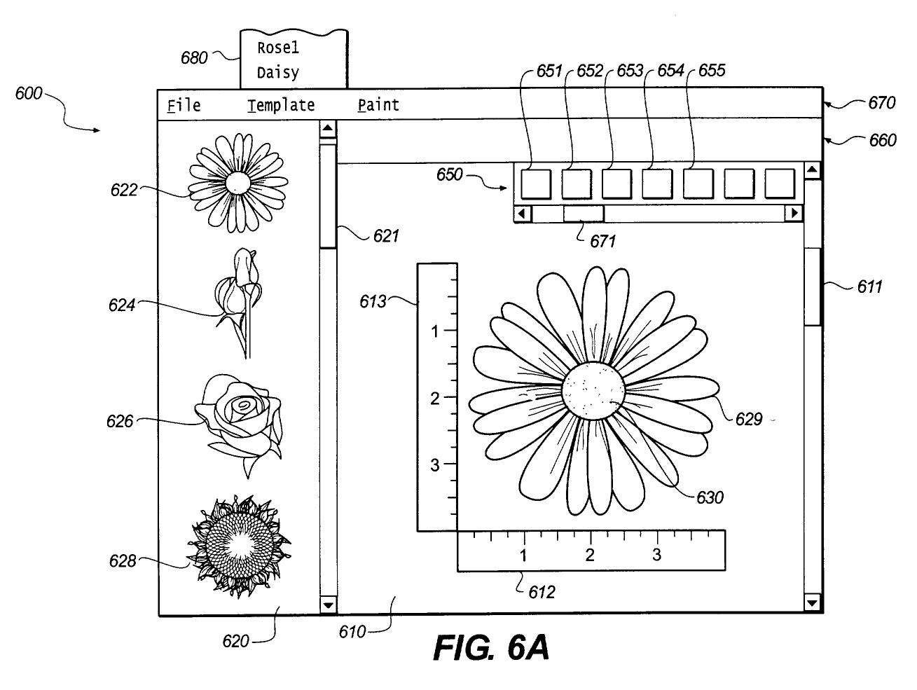

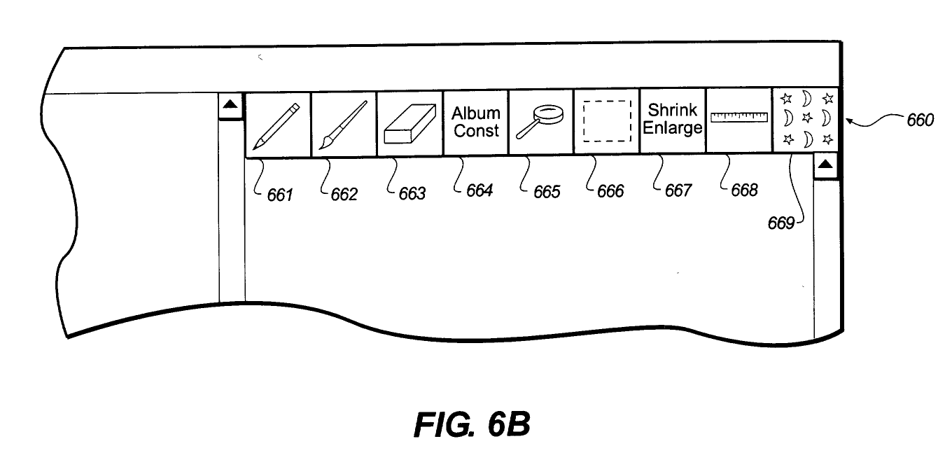

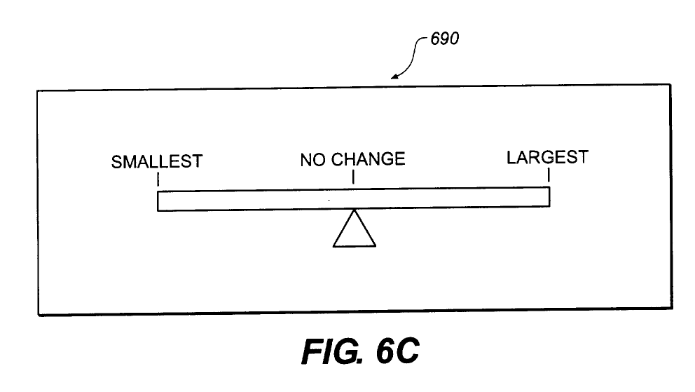

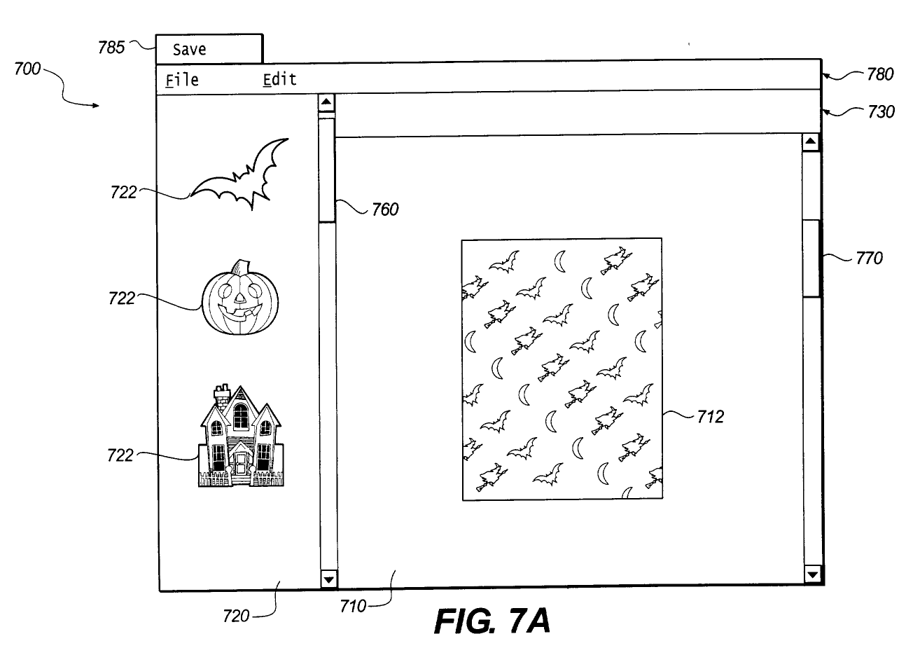

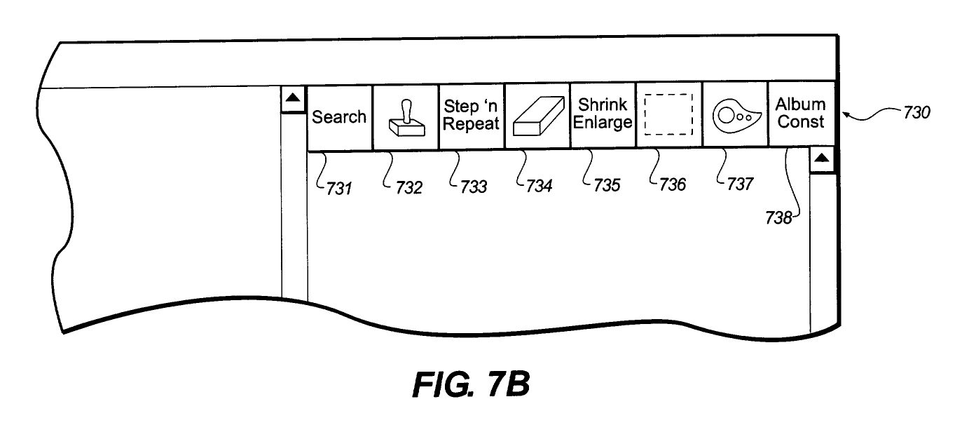

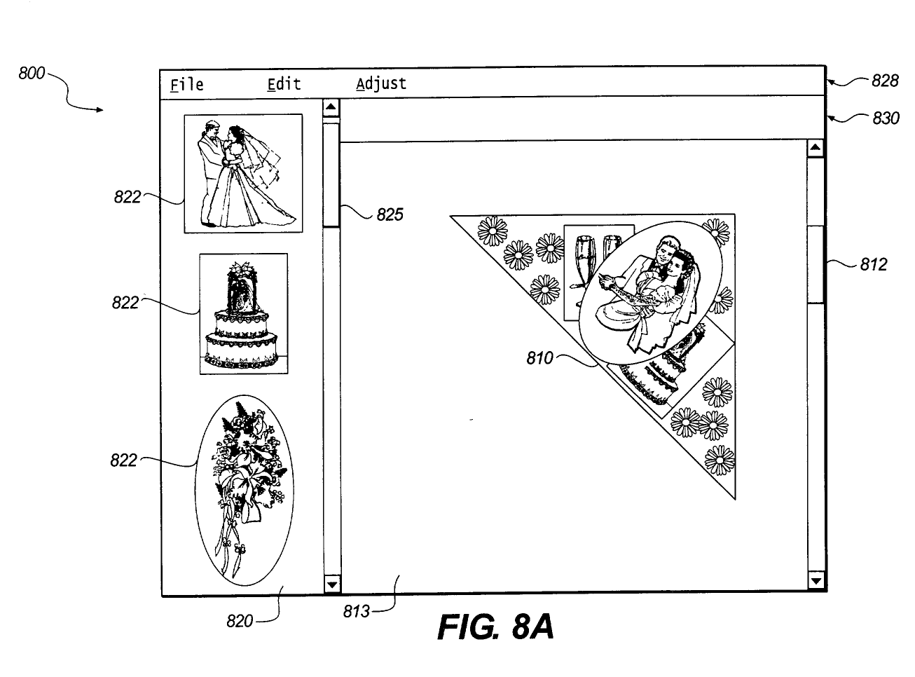

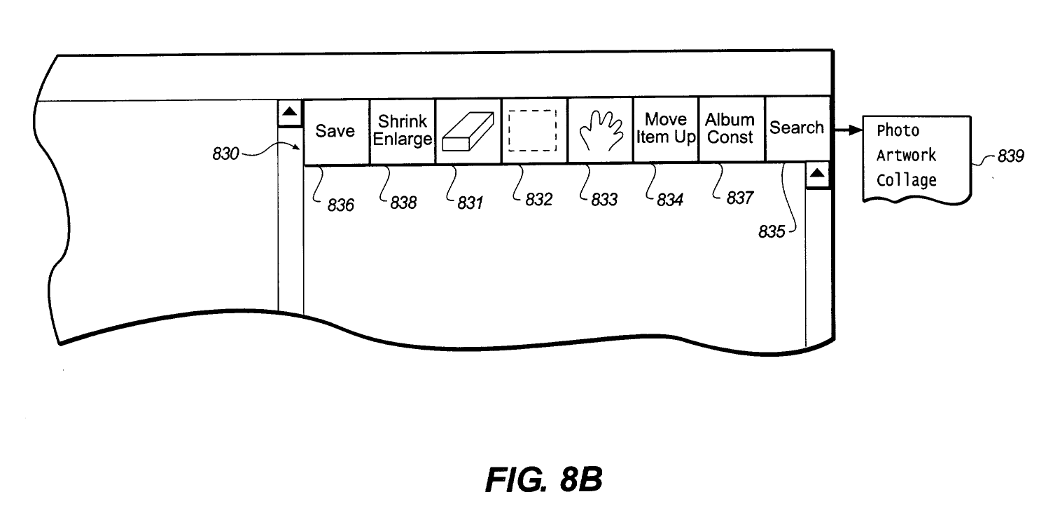

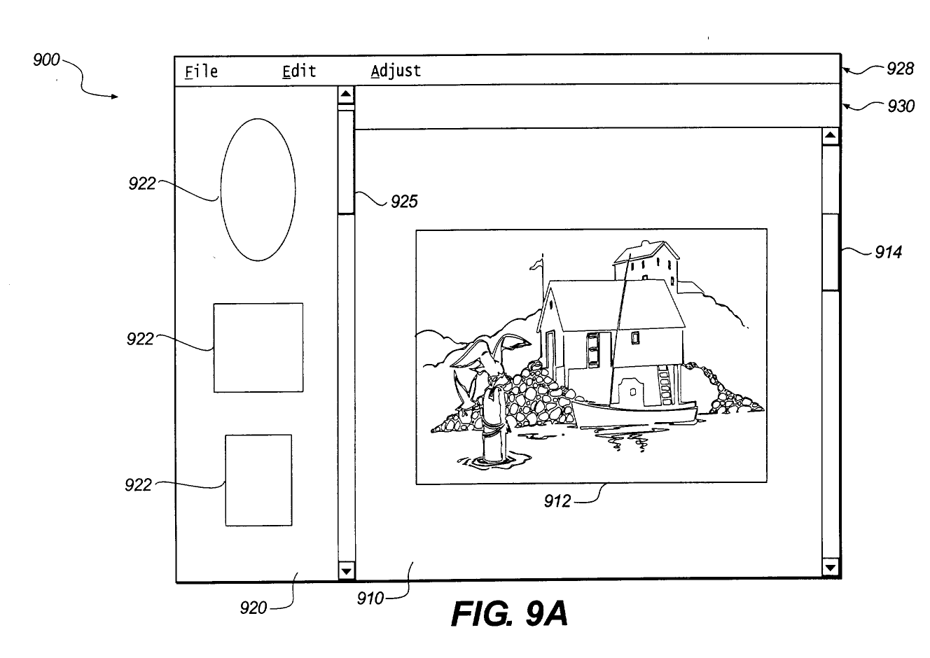

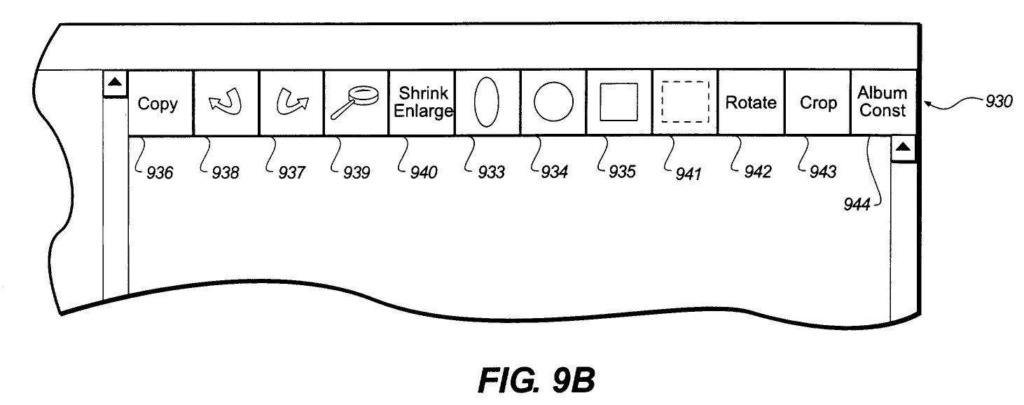

FIG. 3 illustrates one embodiment of a flowchart 300 a user would follow to construct a scrapbook receiver page 210. In operating step 310, a user determines layout for the receiver page 210, by using an album construction window 500 (shown in FIG. 5A). The user can either pick out or specify one of the defined receiver page layouts. A layout can be for a full size album page, or a partial page size, for example, to accommodate a 3×5 or other standard size photograph applied to a self adhesive label. If the user desires to create a layout from scratch, she will use a positioning tool to place the items upon the receiver page 210 which is more fully described in operating step 330. The software will display the layout for the user. Upon completion of operating step 310, wherein the user has determined the layout for the receiver page 210, a user may desire to leave the receiver page construction portion of the flowchart 300, and decide upon one or more of several options of scrapbook artwork creation tools in operating step 320. These scrapbook artwork creation options include importing and preparing images that are found in an image edit-import window shown in FIG. 9A; preparing artwork using a custom artwork tool shown in FIG. 6A; preparing wallpaper or import wallpaper using a wallpaper tool shown in FIG. 7A; or creating corner art using a corner artwork tool shown in FIG. 8A. The creative album software allows the user to import the photographic images using the photo import-editing tool shown in FIG. 9A. Upon choosing one of these options, a user can select another option and or work simultaneously between several options. However, at some point the user will return to the album construction window as shown in FIG. 5A, and described in operating step 330. In operating step 330, the user imports photographs to be included on the receiver page 210 or designates a layout position as blank such that a traditional photograph (silver halide or digital) can be mounted in the layout position. If the user is to include decorative corner artwork or larger size artwork, space will be allocated for the artwork on the receiver page 210 along with the photographs. As such, the user places larger sized artwork and corner artwork on the receiver page 210. Once major components are placed, the user can add wallpaper, add text (annotations or labels), and smaller decorative artwork to the receiver page 210.

Subsequently, in operating step 340, the user decides upon what type of print media she will use. Should the user decide upon printing her creation on pre-punched, full scrapbook media 140, as shown in FIG. 1, the user sends a print signal, in operating step 342, to print a full page raster upon the receiver page 210. Alternatively, if the user desired a partial page layout then she would print out the imagery on label-type media. An image raster is a digital electronic form of the receiver page 210 that contains descriptive information about the image such as resolution, color, and gray scale. Should the user decide upon using labels to enhance previously manually-created scrapbook receiver pages 210, she would send a print signal, such as print artwork 344, print photos 346, or print text 348, or a combination print operation 352 thereof upon the labels. A pre-punched full size album page is then inserted into the scrapbook/album binder 130. Alternatively, a self-adhesive media has its carrier 145 removed and applied to user supplied media 140 and inserted into the album/scrapbook 200.

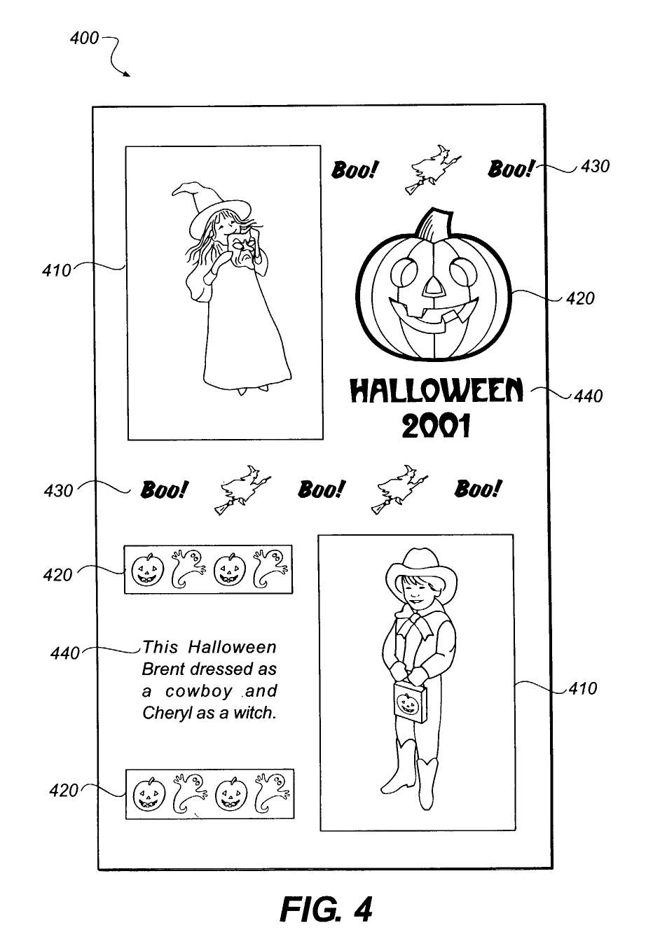

FIG. 4 shows an example of an image raster 400 of a full receiver page 210. Image raster 400 can be applied to multi-purpose media 140 supplied as part of the full scrapbook kit 110, or can be applied to a self-adhesive label media and in turn applied to user supplied media to be inserted into the scrapbook binder 130. Image raster 400 may be printed with a color printer using any one of the popular printing technologies such as ink jet, thermal dye diffusion, or electrophotographic (Xerography) printing. The image raster 400 can be either monochromatic or color, of different sizes, and of different image resolutions (pixels per inch, grey scale depth, and so on). The image raster 400 includes pixels that have originated in the user photos 410, the user artwork 420, the user created wallpaper or background 430, and user supplied text 440. The user artwork 420 may be incorporated into the receiver page image raster 400 and can be either a contone (bit mapped) or line art (vector) format.

Graphical user interfaces (GUIs) are often implemented to provide an average person an easy interface for using operating software. In the present invention several GUIs featuring different operations are used. The present invention implements at least one of several GUIs for the user:

The main, or album (page) construction window (500, shown in FIG. 5A)

The custom artwork template tool window (600, shown in FIG. 6A)

The wallpaper creation tool window (700, shown in FIG. 7A)

The page corner tool window (800, shown in FIG. 8A)

The photo import and edit window (900, shown in FIG. 9A)

The above GUIs may be implemented singularly or in combination with each other. Several of the GUIs (the custom artwork template tool window, the wallpaper creation tool window, the page corner tool window, and the photo imports and edit window) are personalized creative art tools that give a user artistic license and flexibility in designing an album/scrapbook page without relying on pre-formatted choices. Hence, the user is able to create personalized artwork from one or more of the above GUIs.

One such GUI, termed an album construction window 500, is illustrated in FIG. 5A. In this implementation, a digital toolbar 510 is provided for the user at the top of an application screen 520. From this digital toolbar 510, the user will select the operations available in the program such as import photographs (icon 536), print 565, and so on. The user can also leave the album page construction window 500 for one of the personalized creative art tools by clicking on an icon, for example, wallpaper creation tool icon 530 in the tool bar 510, and then reenter the album construction window 500 by clicking on yet another icon, for example, album construction window icon 738 (shown in FIG. 7A) in a tool bar 730 for a wallpaper creation tool 700. An image portfolio window 540 is provided along the left side of the album construction window 500 to display collections of items or choices that the user has available to perform a particular operation within the program. Examples of items contained in the image portfolio 540 include images 546, artwork 544, and electronic wallpaper 542. Once an artwork item has been created with one of the tools, the artwork item is displayed in the image portfolio window 540 shown on the left side of the application screen 520. For example, if the user wishes to add wallpaper 542 to the background of the scrapbook receiver page 210, the box will display wallpaper artwork(s) 542 from the artwork portfolio contained on the CD 120 that the user can choose from. The image and artwork portfolio window 540 will contain not only “canned” artwork used in conventional software, but also artwork that the user has created by using the custom artwork creation tool 544. For example, the image portfolio window 540 contains selected displayed images. When the user decides that the scrapbook receiver page 210 is ready for printing, the software will provide a preview of the printed page.

Album Construction Window

The album construction window 500 is the main window or desktop of the program. The album construction window 500 has an open, blank electronic canvass termed album page canvas window 550 defining an open raster space such that the raster space receives a wide variety of graphics, text, and photos in a random fashion. It is from this window that a user enters and returns from all the other windows listed above. FIG. 5A illustrates the layout of this GUI. Operations that the user will carry out while operating out of this window include but are not limited to: entering one of the four other supporting windows or desktops listed above; performing artwork editing functions such as eraser (also termed delete) 531, grab 545, zoom in/out 568 (as shown in FIG. 5B), cut 557 and paste 539; printing operations 565, such as printer selection, print preview, and print output. Advance operations include pasting pictures and artwork, laying down wallpaper, and labeling photographs. Basic program operations include exiting, saving album page, deleting album page, renaming album page, and accessing existing album pages.

Visual elements of this window (or desktop) include the album page canvas window 550 and the image portfolio window 540 from where each image or artwork, available for use in the album page, is represented by an icon. Image icons represented in the image portfolio window 540 include imagery that is stored in wallpaper, photograph, or custom artwork portfolios associated with the corresponding album page. The user will see the available imagery in these portfolios as icons shown as photographs 546, wallpaper 542, or artwork 544. Annotations are stored as part of the album page file and are readily accessible via the album page canvas 551. If more artwork or image items are available than can be displayed, the user makes use of the portfolio slide bar 548 to scroll through the list. This technique of utilizing a slide bar to access data items contained in a display window is known to developers skilled in the art. An example slide bar implementation in the realm of hypermedia is described in U.S. Pat. No. 6,268,851 entitled “Hypermedia Authoring And Publishing System,” issued Jul. 31, 2001 to Bricklin et al. Likewise, the album page canvas window 550 includes a canvas slide bar 552 to enable the user to scroll to view the portion of the canvas that extends out of view of the window. Above the album page canvas window 550, is a digital toolbar 510 which contains icons representing artistic and user operational functions previously noted above, such as access to the other windows of the creative tool software, residing on CD 120. Editing tools such as erase/delete 531, select or lasso 533, grab 545, cut 557, paste 539, and edit text 538 are included on the digital toolbar 510. The digital toolbar 510 as shown in FIG. 5A can contain icons that allow the user to conveniently move to other portions of the creative album program. These other portions of the creative album program would include access to the wallpaper creation tool 530, the custom artwork template tool 532, the corner artwork tool 534, and the photo import-editing tool 536. The icons shown on digital toolbar 510 are not or do not have to be ordered in any particular fashion. Located above the album canvas page window 550 and the image and artwork portfolio window 540 is the creative album tool's menu bar 560. Upon dragging the computer's mouse 156 (shown in FIG. 1) over the item in the menu bar 560, one will obtain a pull-down menu 561, which in turn can display another rank of pull-down menu items 563 when the mouse is dragged onto the parent menu item. (This is illustrated in FIG. 5B with the user accessing previously created album pages). Some examples of listed menus are file 562, scrapbook receiver page 564, edit 566, zoom 568, and print 565. The menu bar in this and other windows can contain other function menus and pull-down menus.

The primary operations that are of importance to the album construction window 500 include the operation of defining the layout of the album page, the operation of “pasting” items, such as photo images, decorative artwork, and text, onto the canvas; and the drag and drop selection means of repositioning these items and unfinished templates within the electronic canvas.

The “pasting” of images onto the electronic canvas is accomplished using image merging techniques such as those described in U.S. Pat. No. 5,815,645 entitled “Method Of Combining Two Digital Images,” issued Sep. 29, 1998 to Fredlund et al. and/or that described in U.S. Pat. No. 5,459,819 entitled “System For Custom Imprinting A Variety Of Articles With Images Obtained From A Variety Of Different Sources,” issued Oct. 17, 1995 to Watkins et al., or other algorithms that are used by those knowledgeable in the art.

As described in U.S. Pat. No. 5,459,819 (Watkins et al.) and in International Patent Application WO 98/02844 entitled “Method And Apparatus For Mosaic Image Construction,” Filed Jul. 17, 1997 to Peleg, et al., image merger may require adjustment of the images to be merged into a single entity. In the present invention, photo images 546, user artwork 544, and text 538 are adjusted, if required to meet the resolution and color characteristics of the album page canvas window 550. For example, if the imported photograph 546 is of a different resolution than that of the album page canvas window 550, then the album software 105 will interpolate the incoming image to provide a match.

The user saves and names the created album page using either a “save album page” icon 535 in the digital tool bar 510, or through the file menu 562 then selecting the pull-down menu 561. Selecting “save album page” will then bring up a pop-up window assisting the user in naming and saving the album page. When an album page is saved, the following are created: First, a bitmapped image file of the album page to be printed or used as a web page. Second, an information file recording the position of art objects used in the creation of the album page. This information is recorded in a standard graphics language format, such as Postscript. As an example, the Postscript language includes statements such as: %IncludeFile. These Postscript statements are convenient shorthand regarding the positioning of a graphic (photo or artwork) object on the album page. The information file is used to recover data about where and what photo and art items were recorded on the scrapbook receiver page. When the user wishes to edit or change the scrapbook receiver page in another session, with the present invention, creative art tool software on CD 120, the scrapbook receiver page will be readily available for the user. Third, a record is made of the location (for example, on a disk) where user artwork and photos were accessed for the creation of the scrapbook receiver page 210. The information in this information file is valuable, if the user wishes to edit or modify the scrapbook receiver page 210 at a later date. When the user selects an existing album page to be worked upon, the information file is accessed. Now wallpaper, custom artwork, and photos that are listed in the information file will have a representative icon 542, 544, or 546, respectively, as shown in the portfolio window 540. These icons will be displayed automatically when the user opens the album. When the user concludes a work session on the album page canvas window, the content of this information file is updated and the portfolio or artwork, and photo images are recoverable and made available for future use. This operating software and file structure can be implemented in the Linux, Macintosh, and Windows environment.

Custom Artwork Template Tool

The custom artwork template tool 600, shown in FIG. 6A, includes a library of templates 620 that the user can color fill. The templates 622, 624, 626, and 628 can be scaled, such that they can be replicated as a wallpaper pattern or as customized artwork (e.g., a cartoon character) on the scrapbook receiver page 210. FIG. 6A illustrates one embodiment for the custom artwork tool 600. An equivalent process for manual construction of a scrapbook receiver page 210 requires hand tools, such as stencils and large rubber stamps. An example of an artwork created electronically with the custom artwork template tool 600 that one could create also using hand tools is a flower blossom 629. In this example, the user selects a daisy template 622. She uses a paintbrush 662 from a toolbar 660, shown in FIG. 6B, to color in the petals and leaves of the daisy template 622. Colors 651-654 are selected from the color palette tool bar 650. The user scales the size of the redefined image 629, in this example flower artwork, using a measuring tool 668 and a shrink/enlarge tool 667 (shown in FIG. 6B) to obtain the desired size of the artwork necessary, perhaps to place a child's face photo in the center of the flower. The user may select a “photo space color” 655 in the color palette bar 650, to designate this space as allocated to a photo (for information to the album construction page when the user pastes the picture). This is analogous to the person applying glue from a glue stick over a site for a photograph during manual construction of a scrapbook or photo album. The flower is saved and the user is able to access it for use on the album page out of the image portfolio window 540 on the left side of the album construction window 500, as shown in FIG. 5.0.

Visual elements of this interface, shown in FIG. 6A, include an artwork workspace window 610, the template portfolio window 620, and the custom artwork template window menu bar 670.

The artwork workspace window 610 provides a workbench for the user to create custom colored artwork. Supporting components to the custom artwork template tool window 600 depicted in this user interface are the scroll bar 611, ruler guides 612 and 613 (in English or metric units of measure), a color palette tool bar 650, and a toolbar 660, dedicated to the artwork workspace window 610.

The template portfolio window 620 displays templates (selected by the user out of the template library 620) with icons 622, 624, 626, & 628. As an aid in scrolling through the collection of templates selected by the user, a scroll bar 621, is provided.

Templates are brought into the template portfolio window 620 when a user drags the mouse onto the menu bar 670, selects the menu item “template”, and then in turn selects a template icon (622, 624, 626, or 628) from the drop down menu 680. The selected template icon is then added to the template portfolio window 620.

The user creates a custom artwork item by clicking on a template icon in the template portfolio window 620, then dragging it into the artwork workspace window 610. The corresponding template emerges as a predefined image 629 on the artwork workspace 610. The boundaries of the template prevent the user from painting beyond those of the artwork.

The artwork workspace window 610 can be resized by the user with the “shrink/enlarge” tool 667 accessible from the tool bar 660 as shown in FIG. 6B. The shrink/enlarge tool 667 will provide a pop-up shrink/enlarge scroll bar 690, as shown in FIG. 6C, for the user to scale the size of the predefined image 629. In the midspan point of the shrink/enlarge scroll bar is the point of “no change” of the size of the predefined image 629. To the left of the midpoint, the size is scaled down (shrunk), and to the right, the size is increased (enlarged). To make the predefined image 629 larger, the user drags the scroll bar 690 right until the predefined image 629 is scaled up to the desired size. Other tools that may be implemented include delete-erase 663, zoom in/out 665, and selection 666. The toolbar 660 would also include access to the other windows such as the album page construction window 664 and the wallpaper creation tool window 669.

Color is added to the predefined image 629 using the paintbrush 662 or the pencil tools 661. The user fills the outlined region by the template with color from the colors available in the color palette toolbar 650. The user is aided in accessing colors (represented by icons 651 to 654) in the color palette toolbar 650 by using the horizontal scroll bar 671 to scroll through the colors. A color is cleared out by using the erase tool 663 or is overwritten by “painting” the area with another color.

A region is designated as being a site for a photograph by painting the region with the “photospace” paint 655. When the completed predefined image 629 is used in the makeup of an album page, using the album construction window 500, the user drags and drops an image into the region and it is cropped to conform to the shape of the region outlined by the “photospace” paint 655.

When the user is done with a session of artwork creation and wishes to save the artistic creation, the predefined image 629 is then named and saved in a similar fashion as described above for the album page canvas window 550. The file structure of the saved predefined image 629 is also implemented in the same fashion as the album page canvas window 550.

Wallpaper Creation Tool

An example implementation of the window or desktop for the Wallpaper Creation Tool 700 is illustrated in FIG. 7A. This wallpaper creation tool 700 offers the user the ability to create wallpaper from presupplied artwork, or artwork imported from an external source, or artwork created by the user using the custom artwork creation tool 600 described above. To create a wallpaper design, the user utilizes the options available from the wallpaper canvas tool bar 730. For example, to start creating the wallpaper, the selection of the search icon 731 (FIG. 7B) brings in the artwork either from the library of stock images, the user's own library of artwork created with the use of the custom artwork tool 600, or artwork imported from an external source such as a file on CD or disk, or from the internet or an intranet. The custom artwork tool 600 presents a directory listing of artwork images as the user browses through directories. The user selects an artwork of interest by clicking on its file name. The selected image is now added to those representative of the artwork in the portfolio. This newly added artwork icon is added to the display of icons in the window of artwork that have already been placed in the artwork portfolio window 720. A user can access artwork 722 out of view in the portfolio window 720 by using the vertical scroll bar 760. When a user wishes to modify or examine an existing wallpaper creation, the artwork previously brought into the portfolio is automatically displayed when the user selects this existing wallpaper design. Once the user brings in the subject artwork into the portfolio, the artwork is displayed in the artwork portfolio window 720 on the left-hand side of the workspace. The user can bring in several artwork items for use in creating the wallpaper background, and they can be accessed as needed from the artwork portfolio window 720 by dragging them over from the artwork portfolio 720 to the wallpaper canvas 712 with a mouse or other pointing device.

The right side of the window below the tool bar 730 and to the right of the portfolio of artwork 720, is the wallpaper canvas window 710. The user begins creating the wallpaper design by dragging over artwork from the artwork portfolio window 720 to the wallpaper canvas 712 after clicking on a selected icon in the wallpaper canvas toolbar 730. Once the artwork is on the wallpaper canvas 712, the user can change the size of the artwork with the shrink/enlarge tool 735 located in toolbar 730 as shown in FIG. 7B. The user can replicate the pattern across the wallpaper canvas 712 using step and repeat icon 733. A cluster of artworks can also be stepped and repeated across the page when they are selected as a group prior to any step and repeat operation. The user defines this cluster by encircling artwork items in the wallpaper design on the canvas 712, using the select tool 736. The user can also place artwork items around the wallpaper canvas 712 (randomly) using the mouse after activating the “rubber stamp” operation, by clicking on the “rubber stamp” icon 732 in the toolbar. The “rubber stamp” operation is similar to that used by a person manually creating wallpaper for an album page. A manual creation requires using a rubber stamp etched with an artwork design, and stamping the stamp at one or more desired locations. When the electronic user is finished with the wallpaper design, it is saved and accessible via the image portfolio window 540, shown in FIG. 5A.

A scrollbar 770 is provided to aid the user in accessing portions of the wallpaper canvas 712 that may extend out of view of the window 710.

The toolbar 730 includes icons representing graphic tools such as an eraser icon 734, and access to the album construction window 738 and the custom artwork template Tool 737.

The user saves the wallpaper created on the wallpaper canvas 710 using either a “save” icon (not shown) in the tool bar 730, or by using the “File” menu item and pop-up menu 785 from the menu bar 780 similar to the process used for the album page canvas window 550 described above. Wallpaper type artwork uses the same file implementation as the album construction window 500.

Corner Collage Tool

A user can also create corner collages. An example implementation of the window or program desktop for the corner artwork tool 800 is illustrated in FIG. 8A. Upon entering the corner artwork tool window 800, the user is asked (with the aid of a pop-up window) which corner of the page the design will cover. Depending on the corner selected, a triangle-shaped canvas 810 will appear. The triangle-shaped canvas 810 can actually be one of many geometric shapes, including rectangular, oval, elliptical, or have no rigidly defined structure at all. The user selects photos and artwork designs from the photo and artwork portfolio window 820 for use in the collage and drags them over to the triangle-shaped canvas 810. The selected item lays over the triangle-shaped canvas 810 in its default size (i.e., the size of the artwork that the user originally created). For example, if the user had selected a 3×5 photograph, the photograph would dwarf the triangle-shaped canvas 810 and the user would subsequently scale down the size of the photograph, using the scale or shrink/enlarge tool 838 in toolbar 830, as shown in FIG. 5B. The user can scale down the size of the 3×5 photograph in the triangle-shaped canvas 810, however, the best window for the user to prepare the photo or artwork for the collage is in the photo import-editing tool window 910, shown in FIG. 9A and described below.

As the user lays down artwork or photos in the collage, the most recent artwork or photo overlays the artwork or photos in the canvas, thereby creating a collage effect. If a person desires to “move an item up” in the layers of items in the collage, then the user selects the collage-item positioning tool 834 (FIG. 8B) to bring the artwork or photo to a more prominent position in the collage. When the collage design is complete, the user can preview it by printing it out, or save it in the photo and artwork portfolio window 820. Saved corner collages in the photo and artwork portfolio window 820 are represented by icons 822.

Visual elements of the corner artwork tool window 800 include the triangle-shaped canvas 810 for the corner artwork, and photo and artwork portfolio window 820 that may contain photographs and artwork. A vertical scrollbar 825 is part of the photo and artwork portfolio window 820 and assists the user in displaying artwork or photos that may be out of immediate view of the photo and artwork portfolio window 820; A toolbar 830 is provided above the triangle-shaped canvas 810. Icons representing user available operations or functions for the creation of corner artwork are provided for the toolbar 830. A menu bar 828 is located at the very top of corner artwork tool window 800. The triangle-shaped canvas 810 is shown in the corner artwork canvas window 813. The user is provided a vertical scrollbar 812 to aid in viewing portions of the triangle-shaped canvas 810 that may extend out of view in the corner artwork canvas window 813. The toolbar 830 includes user tools represented by icons. Tools other than those described below include delete-erase 831, and select item 832 Icons to access other windows can also be implemented. For example, the user can leave the corner artwork window tool window 800 for the album construction window 500 by clicking icon 837 in the toolbar 830.

The user enters photographs or artwork into the photo and artwork portfolio window 820 using the search icon 835. A sequence of pop-up menus 839 aids the user in searching and moving a photograph or artwork into the photo and artwork portfolio window 820.

The grab or move icon 833 controls the operation of selecting and moving an item either in the photo and artwork portfolio window 820 or the triangle-shaped canvas 810. For example, the grab or move icon 833 enables a user to pull a photo or artwork from the photo and artwork portfolio window 820 into the triangle-shaped canvas 810. The user clicks on the grab or move icon 833, then scrolls to the desired photograph in the photo and artwork portfolio window 820. Next, the user clicks on the selected photo. The icon for the photo is highlighted (in the photo and artwork portfolio window 820) and the user drags it over to the triangle-shaped canvas 810 and drops it in the desired position. Likewise, items in the collage on the triangle-shaped canvas 810 can be moved around using the grab or move icon 833.

A “move item up” icon 834 controls the operation of moving an artwork or photo from the background to the foreground of the collage. The user clicks on the “move item up” icon 834, then clicks on the desired item to be moved up to the foreground. The photo will then appear on top of all the neighboring items in the collage. Examples of image processing techniques that implement this operation by creating the bit-mapped image are described in WO 98/02844. What is described is an implementation on a computer for the technique of occluding a portion of a graphical object by another, the latter object then having the visual effect of being in the foreground. Although the images are merged and the occluded portion of the background image used to create the bitmapped image has been effectively eliminated, the entire raster of the background source image (photo or artwork) is retained as an image linked to the information file associated to the corner artwork. The information file for the corner artwork not only points to the source image, but also instructs the corner artwork tool window 800 where it is positioned in the image raster, and also how the corner artwork tool window 800 is positioned with respect to the foreground and the imagery used to make up the collage.

To save and name a user's artwork, the user selects save icon 836 in the toolbar 830 or accesses the save menu item via the “file” item in the menu bar 828. The process is identical to that used to save or name artwork and so on in the above descriptions of the other creative tools.

Each corner artwork is then saved in a file structure as that described above for an album page. The information file recording the position of art objects used in the creation of the corner artwork has additional parameters which describe the layering of the imagery within the collage in order to recreate it the next time the user accesses this artwork.

Photo Import-Editing Tool

FIG. 9A illustrates one embodiment of a photo import-editing tool 900. The photo import-editing tool 900 enables the user to import photographs and prepare them for use in the scrapbook or photo album. This photo import-editing tool 900 incorporates conventional photo manipulation tools and techniques that are found in a standard repertoire of commands or tools in photo manipulation software packages that are in the market today. The user can install a driver to import photos from a camera or scanner. The user can then perform various image processing operations to improve the appearance of the image, to scale 940 ; to crop 943 , rotate 942, and shape 933 - 935 the image to fit the desired space. The toolbar 930 provides access to functions such as copy 936, select 941, redo 937, undo 938, and zoom in/out 939. The toolbar also provides user access to the album construction window 500 using album construction window icon 944. A photo shape tool or die is provided. The user clicks on one of several photo shape icons 933 - 935 in the toolbar 930 to select a shape. The user selects corresponding shapes with an oval icon 933, a round icon 934, or a square icon 935. Other shapes such as rectangular or trapezoidal may also be selected.

Other visual elements of this GUI include a photo portfolio window 920 for photos. Photos are added to the photo portfolio window 920 attached to the album page by utilizing a search and selection technique as described above for the wallpaper creation tool 700. Photos included in the photo portfolio window 920 are represented by an icon 922. The user can access photo icons that are out of view, but still in this window, by using the vertical scrollbar 925. To the right of the photo portfolio window 920 is the photo workspace window 910. FIG. 9A depicts an example photo image 912 as the subject of a user editing in the photo workspace window 910. The user can view the photo imagery that is outside of view, but still in this window, by using the vertical scrollbar 914. Located above the photo workspace window 910 is a toolbar 930, shown in FIG. 9B, and menubar 928, shown in FIG. 9A.

In operation of the above invention, a user would create a personalized electronic album by opening an album construction window having a portfolio window of images and a blank album page canvas; selecting a creative art tool for adding a personal touch to selected images to make personalized artwork; and creatively modifying the personalized artwork with operations defined in a corresponding toolbar.

The user may also choose electronic wallpaper, a photo and artwork design, text, and define a layout of the blank album page canvas. Moreover, the user can creatively modify the personalized artwork by pasting the personalized artwork in the blank album page canvas; repositioning the personalized artwork in the blank album page canvas; and matching resolution and color characteristics of the personalized artwork canvas with the blank album page.

For making custom artwork, the user selects an unfinished template; drags and drops the selected template onto a blank electronic canvas. The area bounded by the blank electronic canvas is filled with color and designs to produce the custom artwork wherein the custom artwork is of a user-determined size. Finally, the user accepts and saves the custom artwork upon placing the custom artwork into an artwork portfolio.

For making wallpaper artwork the user selects contents of a portfolio window of wallpaper artwork and drags and drops the selected contents of the portfolio window onto a blank electronic canvass. Additionally, the user selects a wallpaper artwork placement operation from a toolbar; selects a wallpaper artwork sizing operation from the toolbar; and overlays wallpaper artwork with selected images, large artwork, and text.

For making corner artwork the user also performs several steps, including selecting contents from a portfolio window of artwork and photos; dragging and dropping the selected contents of the portfolio window onto a blank electronic canvas to create an artistic corner; and overlaying the artistic corner with recently selected photos and artwork. Finally, the user selectively arranges a collage order within the artistic corner.

One other way of incorporating customized images into an electronic album page includes opening a photo import-editing tool; performing image processing such as cropping, rotating, resizing, sharpening, tone and color transformation, shaping, and halftoning; and accepting and saving the customized images in a photo portfolio window for creative use within the electronic album page.

Another embodiment of the electronic album creation system, further includes a means for implementing the unfinished templates to enable the user to apply techniques that are available with manual artistic album methods; and a means for arranging a plurality of recording elements in an array for recording an image on a receiver medium. For example, the user can choose to place an Easter bouquet of flowers and Easter colored eggs as a background or wallpaper for an album page, thus capturing an Easter occasion with their children.

First, the user will use an unfinished template for an Easter egg with a striped pattern as the basis for the egg design. Using the custom artwork tool, the user will color in the different regions of the egg design with the aid of the template. Likewise, with the flower bouquet, the user will color in the flowers, the foliage, and so on. When the painting of colors is complete, the egg and flower artworks are saved to the artwork portfolio. Using the wallpaper creation tool next, the user scales down the size of the egg and the flower bouquet artworks to a size appropriate for use in the wallpaper. The user designs the arrangement of photos, large artwork, and annotations for the album page. Now she applies the wallpaper to the background of the album page. In this example, she chooses to use the rubber stamp tool, to place eggs and Easter flowers at desired locations about the album page. She saves the wallpaper and now moves to the Album construction page. If she observes that she would like to change the position of items in the wallpaper, she moves back to the wallpaper creation tool and edits her creation. Otherwise, the album page is ready for printing or use in electronic form.

If one was to use current offerings of manual tools associated with hand construction of scrapbooks, one could use a plastic template with an Easter egg and a flower bouquet. The user would then fill in color with the use of felt tipped pens. The template is placed in position on the album page under construction wherever the user wishes to lay down eggs and flowers for the Easter wallpaper. Alternatively, the user could use a rubber stamp tool and an alignment tool such as the “Stampaliner Tool”™ to ensure that the multiple impressions of rubber stamps are aligned (multiple colors are used for the different parts of the egg and flower). The user would repeat the impressions of the egg and flower around the album page to create the wallpaper or background.

In another embodiment, the creative album tool can assist the hobbyist by saving hours of labor by replicating portions of the artwork needed to create album pages. It is customary at special family occasions such as weddings, wedding anniversaries, ordinations, dance recitals, and so on, to create a special large album for the person or persons central to the event, and smaller albums for persons close to the central person or event. For example, a wedded couple may have an album created using 8½×11 inch album media, with 40 album pages, while their parents will receive smaller albums created with 6×10 inch or 4×5 inch sized media with 20 album pages. Using the creative album tool, the user will create the wedded couple's album first. Then using the album pages with their attached portfolio of artwork and photos, the user can take a subset of the creations and apply them to the smaller size albums for the parents. The user can then choose to perform all of her creative work electronically for all the albums, or may generate a printed page with photos, annotations, and wallpaper which has personalized artwork added to each album by the creator using hand techniques.

The file structure implemented as part of the creative album tool enables the user to conveniently access artwork and leverage work from previously created album pages, wallpaper, and template created artwork without starting from scratch.

The invention has been described in detail with particular reference to certain embodiments thereof, but it will be understood that variations and modifications can be effected within the spirit and scope of the invention.

### PARTS LIST

100 prior art computer system

110 full scrapbook kit

120 computer disk

130 scrapbook binder

140 multi-purpose media

141 self-adhesive labels

145 carrier

148 hard drive

150 CD or DVD drive

152 monitor

154 keyboard

156 mouse

158 printer

160 paper tray

200 scrapbook

210 receiver page

220 photos

230 user created artwork

240 wallpaper

250 text

300 flowchart

310 operating step

320 operating step

330 operating step

340 operating step

342 operating step

344 operating step

346 operating step

348 operating step

Parts List—continued

350 operating step

352 operating step

400 image raster

410 user photos

420 user artwork

430 user created wallpaper or background

440 user supplied text

500 album construction window

510 digital toolbar

520 application screen

530 wallpaper creation tool icon

531 erase-delete icon

532 custom artwork template icon

533 select or lasso icon

534 corner artwork tool icon

535 save icon

536 photo import tool icon

538 text icon

539 paste icon

540 image portfolio window

542 user created wallpaper

544 custom artwork icon

545 grab icon

546 photo images icon

548 portfolio slide bar

550 album page canvas window

551 user created album page on canvas

557 cut icon

Parts List—continued

560 menu bar

561 pull-down menu

562 file menu

563 pull-down menu

564 scrapbook receiver page

565 print operation

566 edit operation

568 zoom operation

600 custom artwork template tool window

610 artwork workspace window

611 scroll bar

612 horizontal ruler guide

613 vertical ruler guide

620 template portfolio window

621 scrollbar for template portfolio window

622 daisy template

624 rose template

626 rose template

628 template

629 artwork

630 reserved photospace

650 color palette tool bar

651 first color

652 second color

653 third color

654 fourth color

655 photo space color

660 toolbar

Parts List—continued

661 pencil tools

662 paintbrush icon

663 delete/eraser icon

664 album construction icon

665 zoom/view icon

666 selection icon

667 shrink/enlarge icon

668 measuring icon

669 wallpaper tool icon

670 menu bar

671 scroll bar

680 drop down menu

700 wallpaper creation tool window

710 wallpaper canvas window

712 user created wallpaper canvas

720 artwork portfolio window

722 artwork icons

730 toolbar

731 search icon

732 rubber stamp icon

733 step and repeat icon

735 shrink/enlarge icon

736 selection icon

737 custom artwork template

738 album construction window icon

760 artwork portfolio scroll bar

770 wallpaper canvas scroll bar

780 menu bar

Parts List—continued

785 pop-up menu

800 corner artwork tool window

810 triangle-shaped canvas

812 canvas scrollbar

813 corner artwork canvas window

820 photo and artwork portfolio window

822 artwork icons in portfolio

825 vertical scrollbar

828 menu bar

830 toolbar

831 delete-erase icon

832 selector icon

833 grab or move icon

834 move item up icon

835 search icon

839 search pop-up menu icon

836 save icon

837 album construction window icon

838 shrink/enlarge tool

900 photo import-editing tool window

910 photo workspace window

912 example photo image

914 scrollbar for photo workspace window

920 photo portfolio window

922 photo icons

925 scrollbar for photo portfolio window 920

928 menu bar

930 toolbar

Parts List—continued

933 oval icon

934 round icon

935 square icon

936 copy icon

937 redo icon

938 undo icon

939 zoom icon

940 shrink/enlarge icon

941 select icon

942 rotate icon

943 crop icon

944 album construction window icon

What is claimed is:

1. An electronic album creation system, comprising:
a) an album construction window having an open, blank electronic canvas defining an open raster space such that the raster space receives a wide variety of graphics, text, and photos in a random fashion;
b) a portfolio window of selected displayed images;
c) digital toolbars containing icons that represent artistic and operational functions;
d) drag and drop selection means for placing unfinished templates within the blank electronic canvas; and
e) personalized creative art tools that define a user's selective input for artistic composition, color, and placement in the electronic album.

2. The electronic album creation system as claimed in claim 1 wherein the personalized creative art tools include:
e1) a custom artwork template tool;
e2) a wallpaper creation tool;
e3) a page corner tool; and
e4) a photo import and edit window.

3. The electronic album creation system as claimed in claim 1 wherein the portfolio window of selected displayed images include:
b1) images;
b2) artwork; and
b3) electronic wallpaper.

4. The electronic album creation system as claimed in claim 1 wherein the digital toolbars include:
c1) a delete tool; and
c2) a select tool.

5. A method for creating a personalized electronic album, comprising:
a) opening an album construction window having a portfolio window of images and a blank album page canvas;
b) selecting a creative art tool for adding a personal touch to selected images to make personalized artwork; and
c) creatively modifying the personalized artwork with operations defined in a corresponding toolbar.

6. The method claimed in claim 5, wherein step (b) includes:
b1) choosing electronic wallpaper;
b2) choosing a photo and artwork design;
b3) choosing text; and
b4) defining a layout of the blank album page canvas.

7. The method claimed in claim 5 wherein step (c) includes:
c1) pasting the personalized artwork in the blank album page canvas;
c2) repositioning the personalized artwork in the blank album page canvas; and
c3) matching resolution and color characteristics of the personalized artwork canvas with the blank album page canvas.

8. A method for making custom artwork, comprising:
selecting an unfinished template;
dragging and dropping the selected unfinished template onto a blank electronic canvas;
filling an area bounded by the blank electronic canvas with color and designs to produce the custom artwork wherein the custom artwork is of a user-determined size;
accepting and saving the custom artwork; and
placing the custom artwork into an artwork portfolio window.

9. A method for making wallpaper artwork, comprising:
selecting images, foreground artwork, and text;
selecting contents of a portfolio window of wallpaper artwork;
dragging and dropping the selected portfolio window contents onto a blank electronic canvas;
selecting a wallpaper artwork placement operation from a toolbar;
selecting a wallpaper artwork sizing operation from the toolbar; and
overlaying wallpaper artwork with the selected images, foreground artwork, and text.

10. A method for making corner artwork, comprising:
selecting photos or artwork;
selecting contents from a portfolio window of artwork and photos;
dragging and dropping the selected portfolio window contents onto a blank electronic canvas to create an artistic corner;
overlaying the artistic corner with the selected photos or artwork;
selectively arranging a collage order within the artistic corner.

11. A method for incorporating customized images into an electronic album page, comprising:
opening a photo import-editing tool;
performing image processing such as cropping, rotating, resizing, sharpening, tone and color transformation, shaping, and halftoning; and
accepting and saving the customized images in a photo portfolio window for creative use within the electronic album page.

12. A computer program product for performing the method of claim 5.

13. A computer program product for performing the method of claim 6.

14. A computer program product for performing the method of claim 7.

15. A computer program product for performing the method of claim 8.

16. A computer program product for performing the method of claim 9.

17. A computer program product for performing the method of claim 10.

18. A computer program product for performing the method of claim 11.

19. The electronic album creation system claimed in claim 1, further comprising:
f)means for implementing the unfinished templates to enable the user to apply techniques that are available with manual artistic album methods; and
g) means for arranging a plurality of recording elements in an array for recording an image on a receiver medium.
